(19) United States
(12) Patent Application Publication
(10) Pub. No.: US 2007/0073434 A1
(43) Pub. Date: Mar. 29, 2007

(54) Disposable custom coat sizing template

(76) Inventor: Herbert M. Westover, Ironwood, MI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/237,545

(22) Filed: Sep. 28, 2005

(51) Int. Cl. G06F 19/00

(52) U.S. Cl. 700/132

(57) ABSTRACT

A custom clothing sizing template includes an oversized upper body measuring garment adapted to be worn by a customer desiring custom made clothing. The measuring garment includes a pair of overlapping front panels, a back panel and pair of sleeves secured together to form a template. The measuring garment is provided with localized reference lines only on selected portions of the front panels and the sleeves representative of clothing length, sleeve length and waist/hip line measurement for permitting tailored clothing to be manufactured without applying extraneous material to and changing the contour of the template on the customer.

### FIELD OF THE INVENTION

The present invention relates generally to the tailoring of clothing and, more particularly, pertains to the provision of a disposable, non-woven fabric template used in manufacturing a custom tailored garment.

### BACKGROUND OF THE INVENTION

Generally, a customer purchasing clothing visits a retail store or orders the clothing via a catalog or the internet, with the clothing being provided in standardized sizes. Rarely does the purchased clothing properly fit the particular body configuration of the customer requiring the customer to obtain the adjustments from a tailor. In cases where the measuring or tailoring functions were inaccurate, the clothing may need further adjustment requiring further visitation by the customer.

In order to eliminate this cumbersome alteration process and provide better fitting clothing, various methods and systems have been proposed which allow a customer to obtain a ready to wear, custom tailored garment before the clothing is manufactured. Many of these current methods and systems involve the use of a single or multi-pieced template with reference lines or a calibration grid covered by flexible tapes or strips to convey information relating to the specific contour or shape of the customer's body. Such information is sometimes captured by a video system, computerized and provided to a clothing manufacturer to enable the efficient manufacture of clothing to the specific body dimensions of the customer.

The aforementioned methods and systems used for producing tailored clothing still depend upon the taking of a large number of measurements and the use of information capturing technology which unreasonably increases the cost of supplying a tailored item of clothing. Most importantly, such methods and systems require the presence of the customer to obtain the necessary customized measurements.

In the customary manufacture of certain apparel, such as outerwear, it may not be necessary for a customer to provide an overabundance of body measurements or visit a retailer tailoring facility to obtain suitably tailored clothing. Accordingly, it is desirable to provide a more simplified, cost-effective approach for enabling mass production of customized clothing, whereby a customer can more easily, independently and remotely supply information to a manufacturer without the requirements of prior art methods and systems.

### SUMMARY OF THE INVENTION

It is a general object of the present invention to provide custom tailored clothing having a better fit at a lower cost than previously possible with less inconvenience to the customer than with previously known devices.

It is also an object of the present invention to reduce the amount of human labor required in the taking of numerous body measurements to provide customized clothing.

It is a further object of the present invention to enable a customer to obtain an item of tailored clothing without visiting a retail or tailoring facility.

It is an additional object of the present invention to provide a specialized disposable sizing template that aids in the process of obtaining body measurements for the purpose of producing a custom fitted coat.

It is another object of the present invention to provide a simplified method for obtaining specific body measurements of a customer to enable the manufacturer of custom tailored clothing.

In one aspect of the invention, a custom clothing sizing template includes an oversized upper body measuring garment constructed of a disposable, non-woven fabric and adapted to be worn by a customer desiring custom made clothing. The measuring garment includes a pair of overlapping front panels, a back panel, and a pair of sleeves secured together to form a template having a neck opening. The measuring garment is provided with localized reference lines only on selected portions of the front panels and the sleeves representative of clothing length, sleeve length and a waist/hip line measurement for permitting tailored clothing to be manufactured without applying extraneous material to and changing the contour of the template on the customer.

The reference lines include a first set of parallel horizontal reference lines provided on a bottom portion of one of the front panels. The reference lines further include a second set of parallel, horizontal reference lines provided on bottom portions of both sleeves. The reference lines further include a third set of parallel, vertical lines provided on a midportion of the other of the front panels. The reference lines are printed and constantly visible on the template. The template is adapted to be worn by the customer at a location remote from a manufacturer of the custom made clothing. In the preferred embodiment the clothing is a coat. Certain of the reference lines are accompanied by printed numerical and/or descriptive data. An edge of the one of the front panels is aligned with one of the third set of reference lines on the other of the front panels to establish the waist/hip line measurement desired for the custom made clothing.

The invention also contemplates a method of obtaining custom made clothing without requiring a customer to be measured by a measuring professional. The method includes the steps of providing an oversized upper body measuring garment constructed of a disposable, non-woven fabric and adapted to be worn by a customer desiring custom made clothing, the measuring garment including a pair of overlapping front panels, a back panel and a pair of sleeves secured together to form a template having a neck opening, the measurement garment provided with localized reference lines only on a bottom portion of one of the front panels, bottom portions of both sleeves and a midportion of the other of the front panels, the reference lines being representative of clothing length, sleeve length and waist/hip line measurement for permitting tailored clothing to be manufactured without applying extraneous material to and changing the contour of the template on the customer; selecting a desired clothing length using only the reference lines provided on the bottom portion of one of the front panels; selecting a desired sleeve length using only the reference lines provided on the bottom portion of both sleeves; selecting a desired waist/hip line measurement by aligning an edge of the one of the front panels relative to the reference lines provided on the midportion of the other of the front panels; and transmitting the desired clothing length, sleeve length and waist/hip line measurement to a clothing manufacturer so as to create the desired custom made clothing.

Various other objects, features and advantages of the invention will be made apparent from the following description taken together with the drawings.

### BRIEF DESCRIPTION OF SEVERAL VIEWS OF THE DRAWINGS

The drawings illustrate the best mode presently contemplated of carrying out the invention.

In the drawings:

FIG. 1 is a front view of a disposable custom coat sizing template according to the present invention;

FIG. 2 is a rear view of the template of FIG. 1; and

FIG. 3 is a front view of a custom tailored coat manufactured using the template of FIGS. 1 and 2.

### DETAILED DESCRIPTION

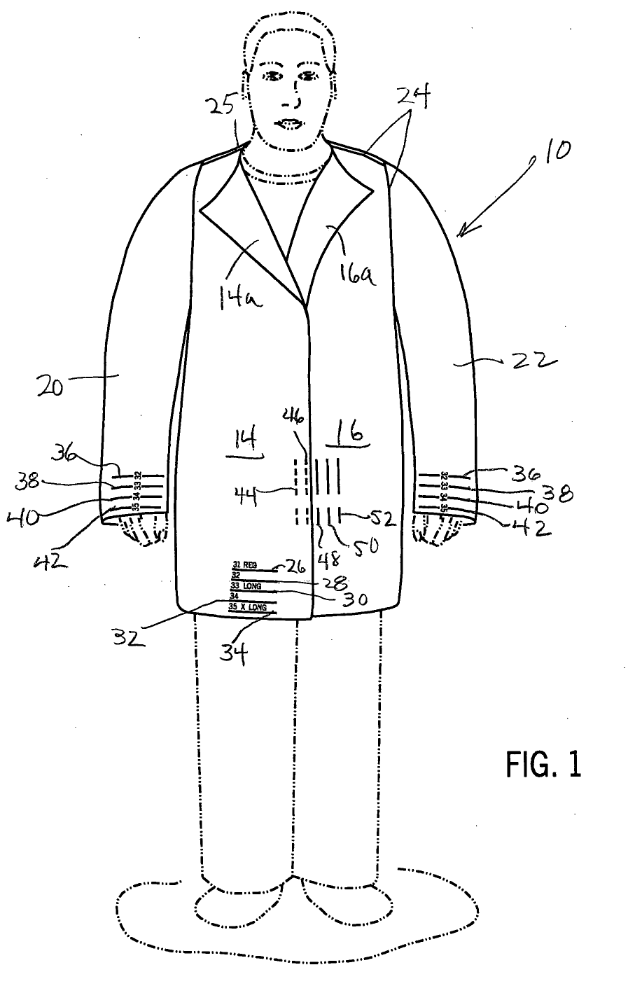

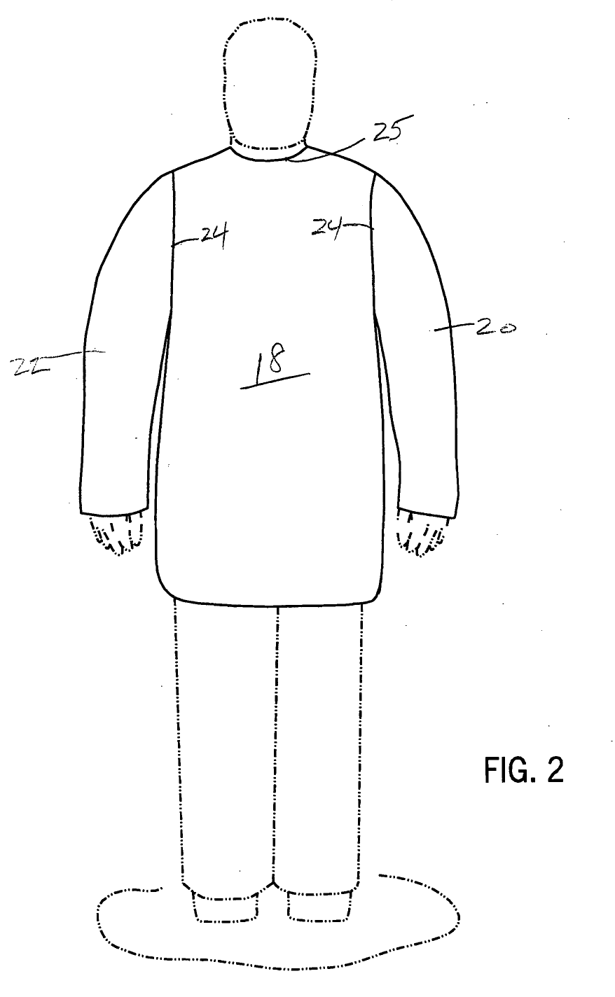

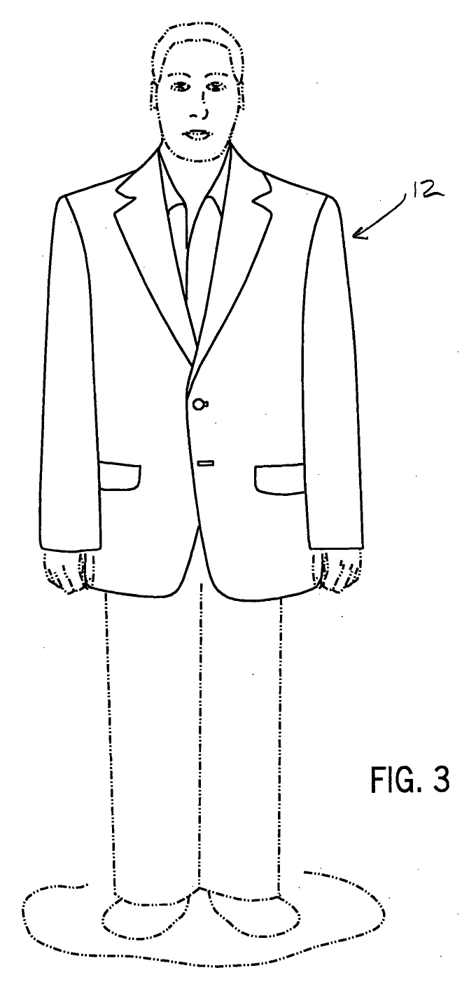

Referring now to FIGS. 1-3, thereshown is a disposable, custom sizing template 10 used to manufacture a custom tailored outer garment, such as a woolen coat 12. A template 10 illustrated in FIGS. 1 and 2 is made in the form of a thin, wearable, oversized upper body garment constructed of a lightweight, throwaway, non-woven fabric. Template 10 includes a pair of overlapping front panels 14, 16, a back panel 18, and a pair of sleeves 20, 22, all of which are secured together along seams 24 so as to create a coat sizing template having a neck opening 25. Front panels 14, 16 are formed with lapels 14a, 16a to more closely simulate a typical coat construction.

In accordance with the invention, the template 10 is provided with a series of constantly visible, printed horizontal and vertical reference lines representative of the length of the coat 12, the length of the coat sleeves and the waist/hip line measurement of the coat 12 desired by a customer. The reference lines are localized meaning that they appear only on specific portions of the template 10. The reference lines are printed as simple lines without any scales thereon and without any need to be covered or taped.

More specifically, the bottom portion of the right front panel 14 of the template 10 is provided with a series of parallel horizontal reference lines 26, 28, 30, 32, 34 accompanied by respective numerical and/or descriptive indicia which show various choices of lengths of a coat 12 to be custom tailored. For example, reference lines 26-34 typically carry lengths of 31-35 inches and may indicate more descriptively that certain of these measurements provide a coat length which is regular, long or extra long.

Likewise, the bottom portions of both sleeves 20, 22 are provided with a plurality of parallel horizontal reference lines 36, 38, 40, 42, accompanied by respective numerical indicia which represent various optional sleeve lengths of the coat 12 desired. For example, reference lines 36-42 typically include sleeve length indicia of 32, 33, 34 and 35 inches. Reference lines 36-42 are provided on both sleeves 20, 22 to accommodate any sleeve length variations for the particular customer.

Additionally, the midportion of the left front panel 16 is provided with a number of parallel vertical reference lines 44, 46, 48, 50, 52 which represent various waist/hip line measurements for the coat 12 desired. Such reference lines 44-52 may or may not carry accompanying indicia.

In use, a customer desiring a custom-tailored coat 12, contacts the coat manufacturer such as by phone, fax or e-mail and requests the template 10 to be sent directly to him/her at a specific address. Upon receiving the template 10, the customer dons the oversized measurement garment over clothing typically intended to be worn under a custom fitted fabric outer coat. Then, using a marking pen or the like a customer indicates his/her preferences for coat and sleeve length relative to reference lines 26-34 and 36-42, respectively. Next, an edge of a right front panel 14 is aligned relative to the desired waist/hip reference lines 44-52 and marked accordingly. It is noted that a customer may mark a preferred measurement between and, in some cases, beyond the designed reference lines 26-52. The desired measurements to be used in manufacture of a custom fit coat 12 are then transmitted back to the coat manufacturer so that the personally tailored coat can be created for the customer. Once the few measurements have been made, the template 10 is simply thrown away.

It will be appreciated that the present invention thus provides a customer with a template and method of using the template to obtain custom made clothing without requiring the customer to visit a retail or tailoring facility and without the need to take numerous body measurements by applying tapes or the like. The printed reference lines are constantly visible, uncovered lines used by themselves to select the desired measurements of a custom fit coat without any need to change the contour of the template when worn by the customer. The cost for providing the disposable non-woven fabric template pales in comparison to that previously required for labor intensive measuring of the customer and the high cost for known video/computer modeling systems.

It is recognized that various equivalents, alternatives and modifications are possible within the scope of the appended claims.

What is claimed is:

1. A custom clothing sizing template comprising:
an oversized upper body measuring garment constructed of a disposable, non-woven fabric and adapted to be worn by a customer desiring custom made clothing, the measuring garment including a pair of overlapping front panels, a back panel, and a pair of sleeves secured together to form a template having a neck opening, the measuring garment being provided with localized reference lines only on selected portions of the front panels and the sleeves representative of clothing length, sleeve length and waist/hip line measurement for permitting tailored clothing to be manufactured without applying extraneous material to and changing the contour of the template on the customer.

2. The sizing template of claim 1, wherein the reference lines include a first set of parallel horizontal reference lines provided on a bottom portion of one of the front panels.

3. The sizing template of claim 2, wherein the reference lines further include a second set of parallel horizontal reference lines provided on bottom portions of both sleeves.

4. The sizing template of claim 3, wherein the reference lines further include a third set of parallel vertical reference lines provided on a midportion of the other of the front panels.

5. The sizing template of claim 1, wherein the reference lines are printed on the template.

6. The sizing template of claim 1, wherein the reference lines are constantly visible on the template.

7. The sizing template of claim 1, wherein the template is adapted to be worn by the customer at a location remote from a manufacturer of the custom made clothing.

8. The sizing template of claim 1, wherein the clothing is a coat.

9. The sizing template of claim 1, wherein certain of the reference lines are accompanied by printed numerical indicia.

10. The sizing template of claim 1, wherein certain of the reference lines are accompanied by a printed descriptive indicia.

11. The sizing template of claim 1, wherein an edge of one of the front panels is aligned with one of the third set of reference lines on the other of the front panels to establish the waist/hip line measurement desired for the custom made clothing.

12. A method of obtaining custom made clothing without requiring a customer to be measured by a measuring professional, the method comprising the steps of:
a) providing an oversized upper body measuring garment constructed of a disposable, non-woven fabric and adapted to be worn by a customer desiring custom made clothing, the measuring garment including a pair of overlapping front panels, a back panel and a pair of sleeves secured together to form a template having a neck opening, the measuring garment provided with localized reference lines only on a bottom portion of one of the front panels, bottom portions of both sleeves and a midportion of the other of the front panels, the reference lines being representative of clothing length, sleeve length and waist/hip line measurement for permitting tailored clothing to be manufactured without applying extraneous material to and changing the contour of the template on the customer;
b) selecting a desired clothing length using only the reference lines provided on the bottom portion of the one of the front panels;
c) selecting a desired sleeve length using only the reference lines provided on the bottom portions of both sleeves;
d) selecting a desired waist/hip line measurement by aligning an edge of the one of the front panels relative to the reference lines provided on the midportion of the other of the front panels; and
e) transmitting the desired clothing length, sleeve length and waist/hip line measurement to a clothing manufacturer so as to create the desired custom made clothing.
